(19) United States
(12) Patent Application Publication
(10) Pub. No.: US 2013/0117635 A1
(43) Pub. Date: May 9, 2013

(54) MEMORY SYSTEM INCLUDING NONVOLATILE MEMORY DEVICE AND CONTROLLING METHOD OF CONTROLLING NONVOLATILE MEMORY DEVICE

(71) Applicants: Dong Ju Ok, Busan (KR); Kyoung Lae Cho, Yongin-si (KR); Dongsub Kim, Seoul (KR)

(72) Inventors: Dong Ju Ok, Busan (KR); Kyoung Lae Cho, Yongin-si (KR); Dongsub Kim, Seoul (KR)

(21) Appl. No.: 13/550,980

(22) Filed: Jul. 17, 2012

(30) Foreign Application Priority Data
Nov. 4, 2011 (KR) 1020110114634

(51) Int. Cl. G06F 12/00; G06F 11/16

(52) U.S. Cl. 714/773; 711/103; 714/E11.054; 711/E12.008

(57) ABSTRACT

Disclosed is a method of controlling a nonvolatile memory device which includes programming data in a user data area of the nonvolatile memory device and state information on logical states of the data in a meta area of the nonvolatile memory device; and adjusting levels of a plurality of read voltages using the state information to read the data from the user data area using the plurality of read voltages having the adjusted levels.

### CROSS-REFERENCE TO RELATED APPLICATIONS

A claim for priority under 35 U.S.C §119 is made to Korean Patent Application No. 10-2011-0114634 filed Nov. 4, 2011, the entirety of which is incorporated by reference herein.

### BACKGROUND

The example embodiments described herein relate to a semiconductor memory device, and more particularly, relate to a memory system including a nonvolatile memory device and a method of controlling a nonvolatile memory device.

A semiconductor memory device is a memory device which is fabricated using semiconductors such as silicon (Si), germanium (Ge), gallium arsenide (GaAs), indium phosphide (InP), and the like. Semiconductor memory devices are classified into volatile memory devices and nonvolatile memory devices.

The volatile memory devices may lose stored contents at power-off. The volatile memory devices include a static RAM (SRAM), a dynamic RAM (DRAM), a synchronous DRAM (SDRAM), and the like. The nonvolatile memory devices may retain stored contents even at power-off. The nonvolatile memory devices include a read only memory (ROM), a programmable ROM (PROM), an electrically programmable ROM (EPROM), an electrically erasable and programmable ROM (EEPROM), a flash memory device, a phase-change RAM (PRAM), a magnetic RAM (MRAM), a resistive RAM (RRAM), a ferroelectric RAM (FRAM), and the like. The flash memory device is roughly divided into a NOR type and a NAND type.

### SUMMARY

Example embodiments provide a method of controlling a nonvolatile memory device. The method comprises programming data in a user data area of the nonvolatile memory device and state information on logical states of the data in a meta area of the nonvolatile memory device; and adjusting levels of a plurality of read voltages using the state information to read the data from the user data area using the plurality of read voltages having the adjusted levels.

In example embodiments, the adjusting levels of a plurality of read voltages using the state information to read the data from the user data area using the plurality of read voltages having the adjusted levels comprises programming first data in first memory cells of the user data area and second memory cells of a buffer area of the nonvolatile memory device; receiving second data, reading the first data from the second memory cells, coarse programming the first and second data in the first memory cells, and programming the second data in third memory cells of the buffer area; and reading the first and second data from the second and third memory cells, grouping logical states, which the first and second data indicate, into a plurality of groups, counting the number of data in each of some groups of the plurality of groups to generate the state information, and fine programming the first and second data in the first memory cells, and programming the state information in the meta area.

In example embodiments, the first data includes Least Significant Bit (LSB) data and Central Significant Bit (CSB) data.

In example embodiments, the second data include Most Significant Bit (MSB) data.

In example embodiments, the meta area includes spare memory cells connected to word lines of the nonvolatile memory device.

In example embodiments, the meta area includes at least one memory block.

In example embodiments, the state information includes information on the number of data of groups of logical states of a part of the first data and the number of data of groups of logical states of a part of the second data.

In example embodiments, the method further comprises reading the first and second data from the first memory cells; performing error correction on the first and second data; and if the error correction is failed, reading the state information from the meta area, counting groups of logical states of the read first and second data to generate count information, comparing the state information and the count information to adjust levels of the read voltages, and reading the first and second data using the read voltages having the adjusted levels.

In example embodiments, when the number of data in an nth group of the state information is smaller than the number of data in an nth group of the count information, a level of a read voltage corresponding to the nth group increases.

In example embodiments, when the number of data in an nth group of the state information is smaller than the number of data in an nth group of the count information, a level of a read voltage corresponding to the nth group decreases.

In example embodiments, logical states that the first and second data indicate form two groups according to a level of a read voltage used when LSB data is read, respectively.

In example embodiments, logical states that the first and second data indicate form three groups according to levels of read voltages used when CSB data is read, respectively.

In example embodiments, logical states that the first and second data indicate form five groups according to levels of read voltages used when MSB data is read, respectively.

In example embodiments, data numbers of one of two groups corresponding to the LSB data, two ones of three groups corresponding to the CSB data, and four ones of five groups corresponding to the MSB data are counted as the state information and the count information.

Example embodiments also provide a memory system which comprises a nonvolatile memory device; and a controller configured to control the nonvolatile memory device, wherein the controller comprises a random access memory storing data to be programmed in the nonvolatile memory device and data read from the nonvolatile memory device; and a state counter configured to count the number of data in each of groups of logical states of data stored in the random access memory; and wherein the controller controls the nonvolatile memory device to adjust levels of read voltages of the nonvolatile memory device according to a count value of the data to be programmed and a count result of the read data and to perform a read operation using read voltages having the adjusted levels.

Example embodiments provide a method of handling data of a nonvolatile memory device including generating state information based on the data, the data representing a plurality of logic values each of which corresponds to one of a plurality of different logic states, the state information identifying a distribution of the logic states corresponding to the plurality of logic values; programming the data and the state information into the nonvolatile memory device; and reading the programmed data using the state information.

The reading may include adjusting levels of a plurality of read voltages based on the state information, and reading the data from a user data area of the nonvolatile memory device using the plurality of read voltages having the adjusted levels.

The adjusting may include reading the programmed data; generating count information based on the programmed data, the count information identifying a distribution of the logic states corresponding to the plurality of logic values; generating a comparison result based on the count information and the programmed state information; and adjusting levels of the plurality of read voltages based on the comparison result.

The plurality of different logic states may be arranged into a plurality of groups such that each of the plurality of groups includes one or more of the plurality of logic states, and for each of the plurality of groups, the state information indicates how many of the logic values of data correspond to logic states are included in the group.

### BRIEF DESCRIPTION OF THE FIGURES

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram schematically illustrating a memory system according to at least one example embodiment.

FIG. 2 is a flowchart illustrating a method of controlling a nonvolatile memory device according to at least one example embodiment.

FIG. 3 is a block diagram schematically illustrating a nonvolatile memory device in FIG. 1.

FIG. 4 is a flowchart illustrating a program method according to at least one example embodiment.

FIG. 5 is a diagram for describing variations in threshold voltage distributions of memory cells when first and second data are programmed in a user data area.

FIG. 6 is a diagram illustrating groups of logical states formed by LSB data, CSB data, and MSB data according to at least one example embodiment.

FIG. 7 is a flowchart illustrating a read method according to at least one example embodiment.

FIG. 8 is a flowchart for describing an operation S235 in FIG. 7 in detail.

FIGS. 9 through 11 are diagrams for describing a procedure in which count information CI is generated.

FIG. 12 is a diagram illustrating groups of logical states formed by LSB data, CSB data, and MSB data according to at least one example embodiment.

FIG. 13 is a diagram illustrating another example for generating state information SI and count information CI.

FIG. 14 is a block diagram schematically illustrating a memory system according to at least one example embodiment.

FIG. 15 is a block diagram schematically illustrating a nonvolatile memory device in FIG. 14.

FIG. 16 is a block diagram schematically illustrating an application of a memory system in FIG. 1.

FIG. 17 is a diagram illustrating a memory card according to at least one example embodiment.

FIG. 18 is a diagram illustrating a solid state drive according to at least one example embodiment.

FIG. 19 is a block diagram illustrating a computing system according to at least one example embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

The terms “selected bit line” or “selected bit lines” may point at a bit line or bit lines, connected to a cell transistor to be programmed or read, from among a plurality of bit lines. The terms “unselected bit line” or “unselected bit lines” may point at a bit line or bit lines, connected to a cell transistor to be program or read inhibited, from among a plurality of bit lines.

The term “selected word line” may point at a word line, connected to a cell transistor to be programmed or read, from among a plurality of word lines. The terms “unselected word line” or “unselected word lines” may point at the remaining word line or word lines of the plurality of word lines other than the selected word line or word lines.

The terms “selected memory cell” or “selected memory cells” may indicate memory cells to be programmed or read from among a plurality of memory cells. The terms “unselected memory cell” or “unselected memory cells” may indicate the remaining memory cells of a plurality of memory cells other than the selected memory cell or memory cells.

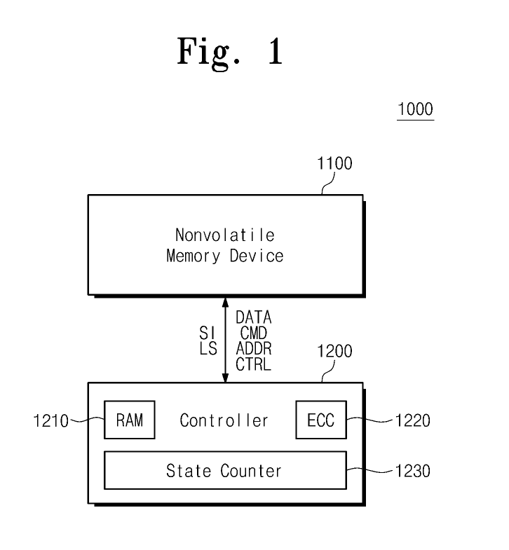

FIG. 1 is a block diagram schematically illustrating a memory system according to at least one example embodiment. Referring to FIG. 1, a memory system 1000 may include a nonvolatile memory device 1100 and a controller 1200.

The nonvolatile memory device 1100 may include a Read Only Memory (ROM), a Programmable ROM (PROM), an Electrically Programmable ROM (EPROM), an Electrically Erasable and Programmable ROM (EEPROM), a flash memory, a Phase-change RAM (PRAM), a Magnetic RAM (MRAM), a Resistive RAM (RRAM), a Ferroelectric RAM (FRAM), and the like. For ease of description, it is assumed that the nonvolatile memory device 1100 is a flash memory. That is, the nonvolatile memory device 1100 may store data using threshold voltages of memory cells.

The controller 1200 may be configured to control the nonvolatile memory device 1100. The controller 1200 may control program, read, erase, and background operations of the nonvolatile memory device 1100. The controller 1200 may exchange data with the nonvolatile memory device 1100. The controller 1200 may provide the nonvolatile memory device 1100 with an address ADDR, data, metadata, a seed, and a control signal CTRL.

The controller 1200 may include a RAM 1210, an error correction code 1220, and a state counter 1230. The RAM 1210 may store data to be programmed in the nonvolatile memory device 1100 or data read out from the nonvolatile memory device 1100. The RAM 1210 may include SRAM.

The error correction code 1220 may correct an error of data, stored in the RAM 1210, which is read out from the nonvolatile memory device 1220. The error correction code 1220 may include at least one of a BCH (Bose-Chaudhuri-Hocquengherm) code, an RS (Reed-Solomon) code, a turbo code, an LDPC (Low Density Parity Check) code, or the like.

The state counter 1230 may count a data number in each of groups of logical states of data stored in the RAM 1210. The controller 1200 may generate state information SI and a level shift signal LS according to a count result of the state counter 1230. The state information SI may include information on the number of each of groups of logical states of data to be programmed in the nonvolatile memory device 1100. The level shift signal LS may be a signal of adjusting levels of read voltages of the nonvolatile memory device 1100. The state information SI and the level shift signal LS may be transferred to the nonvolatile memory device 1100.

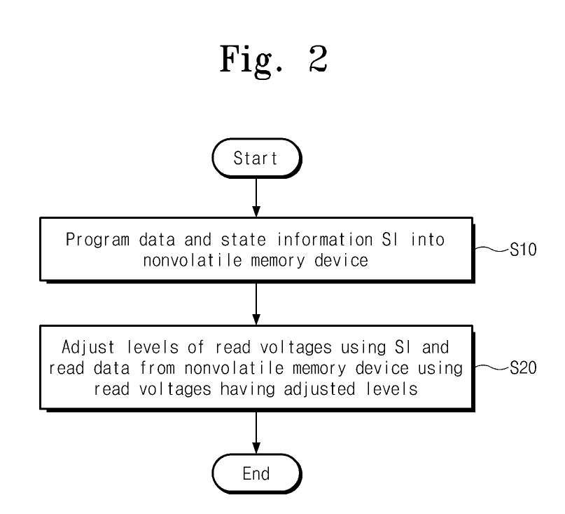

FIG. 2 is a flowchart illustrating a method of controlling a nonvolatile memory device according to at least one example embodiment. Referring to FIGS. 1 and 2, in operation S10, data and state information SI may be programmed in a nonvolatile memory device 1100. In operation S20, levels of read voltage may be adjusted according to the state information SI, and data may be read from the nonvolatile memory device 1100 based on read voltages having the adjusted levels.

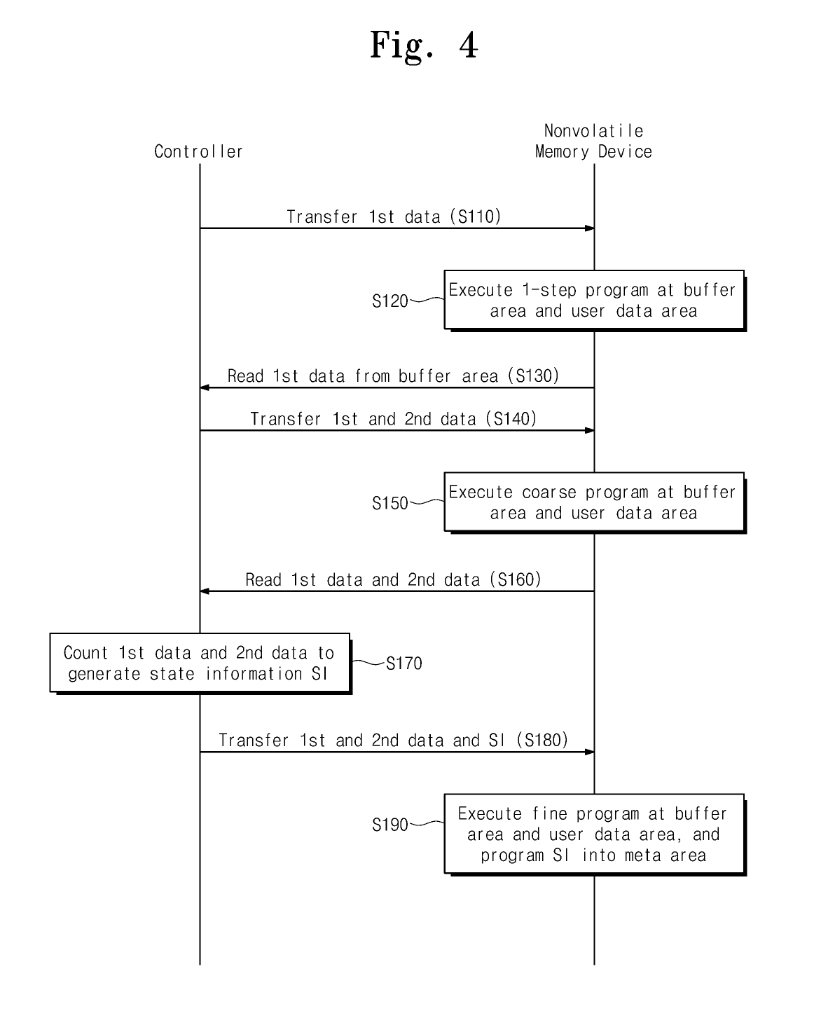

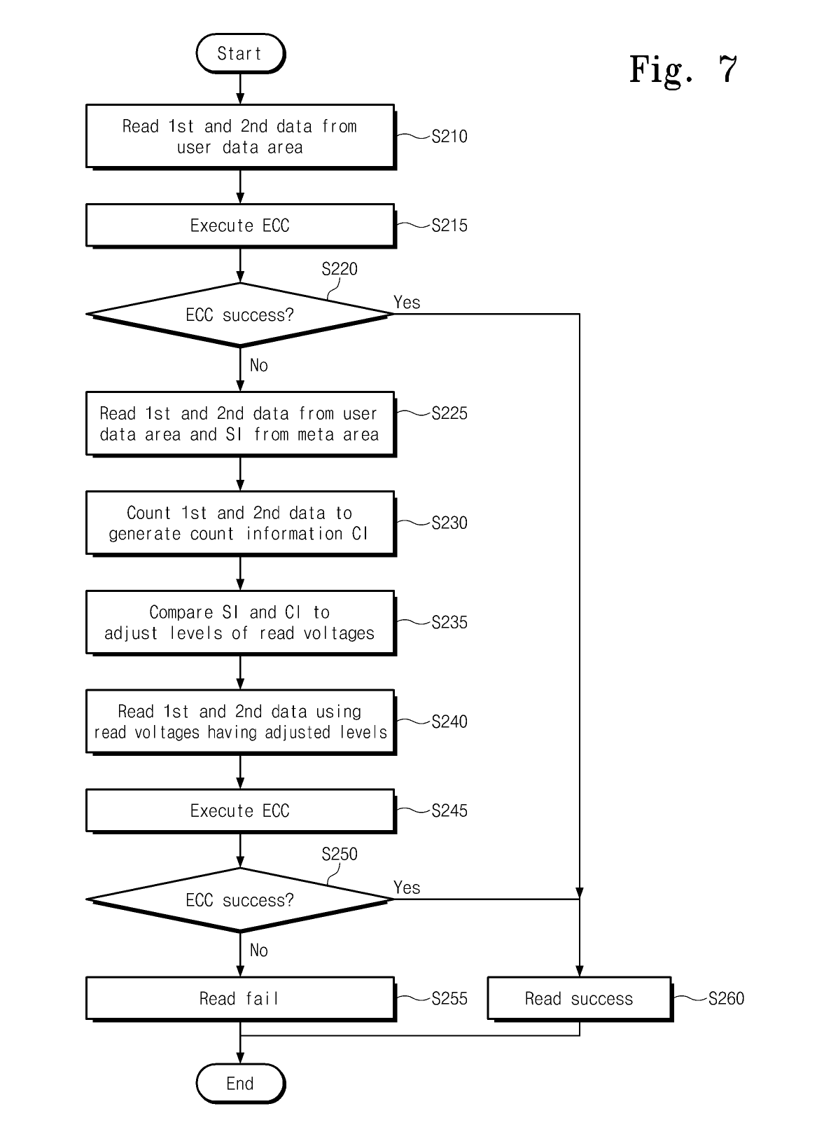

The operation S10 will be more fully described with reference to FIG. 4, and the operation S20 will be more fully described with reference to FIG. 7.

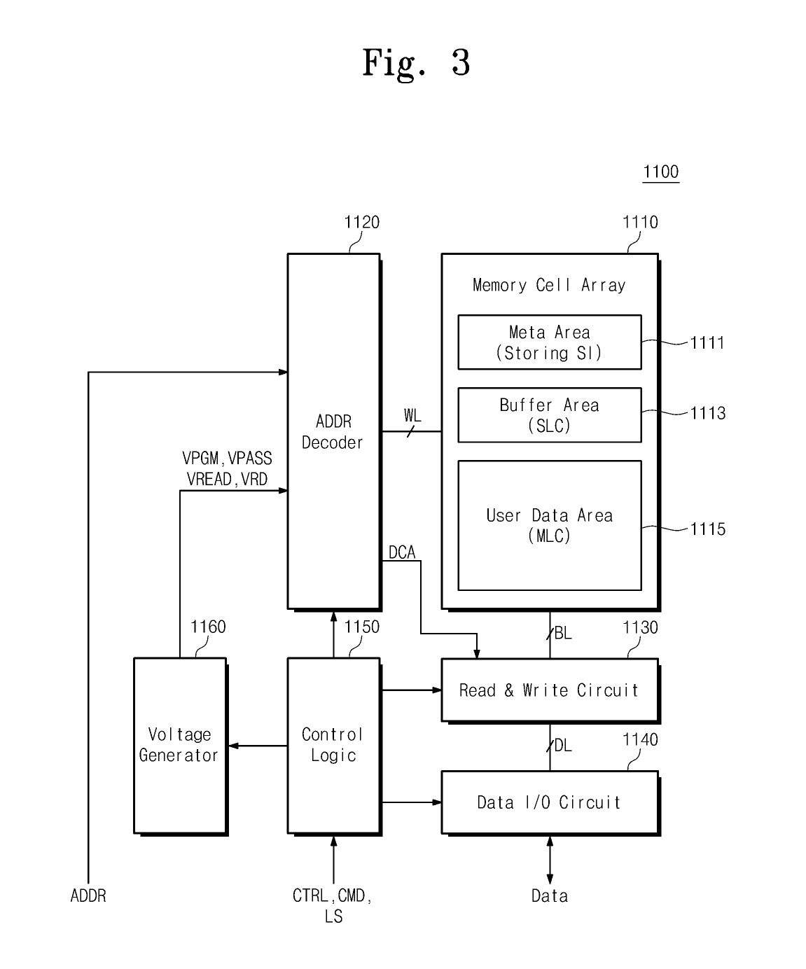

FIG. 3 is a block diagram schematically illustrating a nonvolatile memory device in FIG. 1. Referring to FIG. 3, a nonvolatile memory device 1100 may include a memory cell array 1110, an address decoder 1120, a read/write circuit 1130, a data input/output circuit 1140, control logic 1150, and a voltage generator 1160.

The memory cell array 1110 may be connected to the address decoder 1120 via word lines WL and to the read and write circuit 1130 via bit lines BL. The memory cell array 1100 may include a plurality of memory cells. In example embodiments, memory cells arranged in a row direction may be connected to the word lines WL, and memory cells arranged in a column direction may be connected to the bit lines BL. In example embodiments, the memory cell array 1100 may be formed of a plurality of memory cells each storing one or more bits of data.

The memory cell array 1110 may include a meta area 1111, a buffer area 1113, and a user data area 1115.

The meta area 1111 may store state information SI. The buffer area 1113 may further store data being stored in the user data area 1115. The user data area 1115 may store data to be programmed by a user.

The buffer area 1113 may include single-level cells, each of which stores 1-bit data. The user data area 1115 may include multi-level cells, each of which stores a plurality of data bits.

The meta area 1111 may include spare memory cells. For example, normal memory cells of memory cells connected to a word line may form the user data area 1115 or the buffer area 1113, and the spare memory cells may form the meta area 1111.

The meta area 1111 may include at least one memory block. That is, all memory cells in a specific memory block may be assigned to the meta area 1111.

The address decoder 1120 may be connected to the memory cell array 1110 via the word lines WL. The address decoder 1120 may be configured to operate responsive to the control of the control logic 1150. The address decoder 1120 may receive an address ADDR from the outside.

The address decoder 1120 may be configured to decode a row address of the input address ADDR. Using the decoded row address, the address decoder 1120 may select the word lines WL. The address decoder 1120 may be configured to decode a column address of the input address ADDR. The decoded column address DCA may be sent to the read and write circuit 1130. In example embodiments, the address decoder 1120 may include constituent elements such as a row decoder, a column decoder, an address buffer, and the like.

The address decoder 1120 may receive a program voltage VPGM, a pass voltage VPASS, a non-selection read voltage VREAD, and a read voltage VRD from the voltage generator 1160. At programming, the address decoder 1120 may apply the program voltage VPGM to a selected word line and the pass voltage VPASS to unselected word line. At reading, the address decoder 1120 may apply the read voltage VRD to a selected word line and the non-selection read voltage VREAD to unselected word lines.

The read and write circuit 1130 may be connected to the memory cell array 1110 via the bit lines BL and to the data input/output circuit 1140 via data lines DL. The read and write circuit 1130 may operate responsive to the control of the control logic 1150. The read and write circuit 1130 may be configured to receive the decoded column address DCA from the address decoder 1120. Using the decoded column address DCA, the read and write circuit 1130 may select the bit lines BL.

In example embodiments, the read and write circuit 1130 may receive data from the data input/output circuit 1140 to write the input data in the memory cell array 1110. The read and write circuit 1130 may read data from the memory cell array 1110 to transfer it to the data input/output circuit 1140. The read and write circuit 1130 may read data from a first storage region of the memory cell array 1110 to write it in a second storage region of the memory cell array 1110. For example, the read and write circuit 1130 may be configured to perform a copy-back operation.

In example embodiments, the read and write circuit 1130 may include constituent elements such as a page buffer (or, a page register), a column selector, and the like. In other example embodiments, the read and write circuit 1130 may include constituent elements such as a sense amplifier, a write driver, a column selector, and the like.

The data input/output circuit 1140 may be connected to the read and write circuits 1130 via the data lines DL. The data input/output circuit 1140 may operate responsive to the control of the control logic 1150. The data input/output circuit 1140 may be configured to exchange data with an external device. The data input/output circuit 1140 may be configured to transfer data provided from the external device to the read and write circuit 1130 via the data lines DL. The data input/output circuit 1140 may be configured to output data transferred via the data lines DL from the read and write circuit 1130 to the external device. In example embodiments, the data input/output circuit 1140 may include a constituent element such as a data buffer.

The control logic 1150 may be connected to the address decoder 1120, the read and write circuit 1130, and the data input/output circuit 1140. The control logic 1150 may be configured to control an overall operation of the nonvolatile memory device 1100. The control logic 1150 may operate responsive to a control signal CTRL, a command CMD, and a level shift signal LS transferred from the external device.

The voltage generator 1160 may operate according to the control of the control logic 1150. The voltage generator 1160 may be configured to generate various voltages used for operations of the nonvolatile memory device 1100. For example, the voltage generator 1160 may generate the program voltage VPGM, the pass voltage VPASS, the non-selection read voltage VREAD, and the read voltage VRD. The program voltage VPGM, the pass voltage VPASS, the non-selection read voltage VREAD, and the read voltage VRD may be transferred to the address decoder 1120. The voltage generator 1160 may adjust a level of the read voltage VRD according to the control of the control logic 1150.

FIG. 4 is a flowchart illustrating a program method according to at least one example embodiment. In example embodiments, FIG. 4 shows a program operation S10 in FIG. 2 in detail. Referring to FIGS. 1, 3, and 4, in operation S110, a controller 1200 may transfer first data to a nonvolatile memory device 1100. The first data may include Least Significant Bit (LSB) data and Central Significant Bit (CSB) data.

In operation S120, the nonvolatile memory device 1100 may perform 1-step programming. The first data may be programmed in a user data area 1115 and a buffer area 1113 of a memory cell array 1110. The first data may be programmed in memory cells connected to a word line in the user data area 1115. The LSB data and the CSB data in the first data may be programmed in memory cells connected to two word lines of the buffer area 1113.

In operation S130, the controller 1200 may read the first data from memory cells of the buffer area 1113 of the nonvolatile memory device 1100. In operation S140, the controller 1200 may transfer the first data and second data to the nonvolatile memory device 1100. The second data may include Most Significant Bit (MSB) data.

In operation S150, the nonvolatile memory device 1100 may perform coarse programming. The first and second data may be coarse programmed in memory cells connected to a word line of the user data area 1115. The nonvolatile memory device 1100 may program the LSB data, the CSB data, and the MSB data in memory cells connected to a plurality of word lines of the buffer area 1113.

In operation S160, the controller 1200 may read the first and second data from the buffer area 1113 of the nonvolatile memory device 1100. The controller 1200 may count the first and second data to generate state information SI. For example, the controller 1200 may group a plurality of logical states formed by the LSB data, the CSB data, and the MSB data into a plurality of state groups, and may generate the state information SI by counting a data number of each state group.

In operation S180, the controller 1200 may transfer the first and second data and the state information SI to the nonvolatile memory device 1100. In operation S190, the nonvolatile memory device 1100 may perform fine programming. The nonvolatile memory device 1100 may fine program memory cells, connected to a word line of the user data area 1115, with the first and second data. The nonvolatile memory device 1100 may program the state information SI in a meta area 1111.

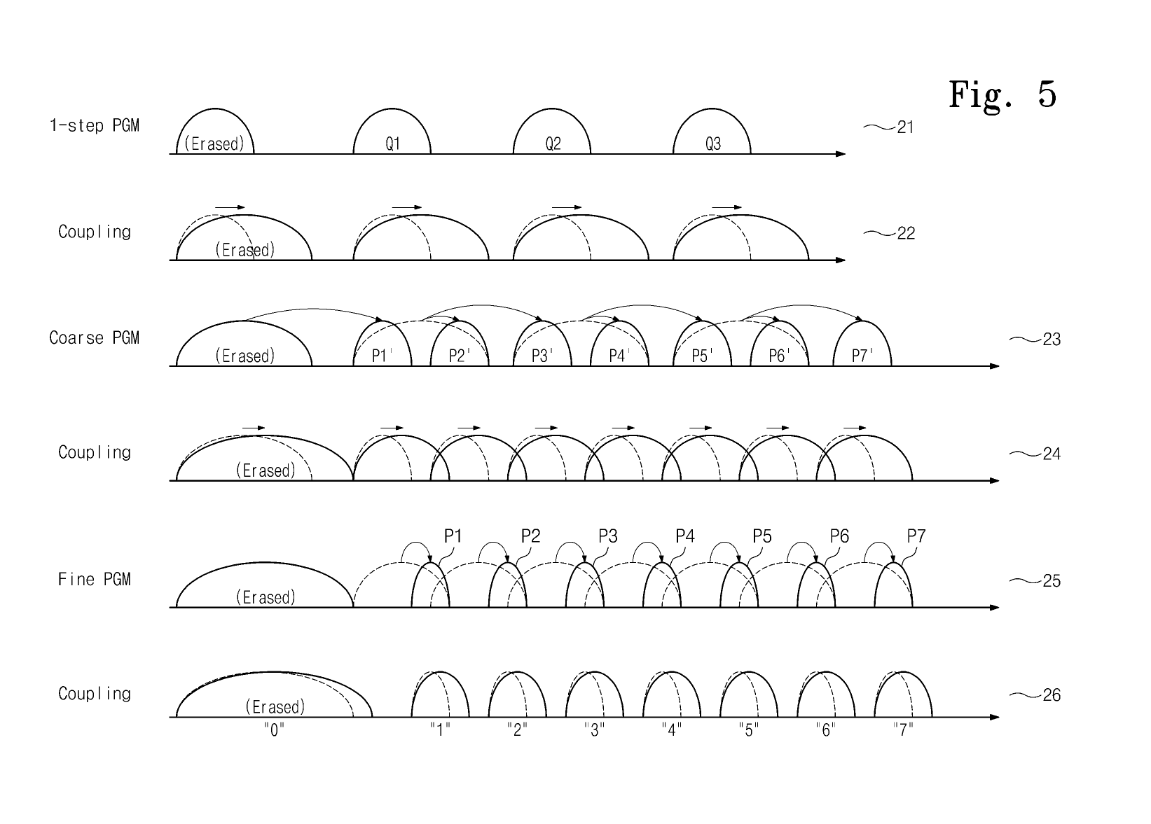

FIG. 5 is a diagram for describing variations in threshold voltage distributions of memory cells when first and second data are programmed in a user data area. In FIG. 5, a horizontal axis may indicate a threshold voltage of a memory cell, and a vertical axis may indicate the number of memory cells.

Referring to FIGS. 1 through 5, if 1-step programming is executed in operation S120, LSB data and CSB data may be programmed in memory cells connected to a first word line of a user data area 1115. The memory cells may be programmed to have an erase state and intermediate program states Q1, Q2, and Q3. At this time, the LSB data may be programmed in memory cells connected to a first word line of a buffer area 1113, and the CSB data may be programmed in memory cells connected to a second word line of the buffer area 1113. Threshold voltage distributions of memory cells, connected to a first word line of the user data area 1115, formed after execution of the 1-step programming may be illustrated in a box 21.

When programming (e.g., 1-step programming) is performed on a second word line adjacent to the first word line of the user data area 1115, threshold voltage distributions of memory cells connected to the first word line may widen due to the coupling effect. Threshold voltage distributions of memory cells, connected to the first word line of the user data area 1115, formed after the coupling is generated may be illustrated in a box 22.

When coarse programming is performed, the LSB data and the CSB data may be read out from the buffer area 1113 being a Single-Level Cell (SLC) area. Thus, although the user data area 1115 experiences the coupling, the LSB and CSB data may be read normally.

If the coarse programming is carried out, the LSB data, the CSB data, and the MSB data may be programmed in memory cells connected to the first word line of the user data area 1115. The memory cells may be programmed to have the erase state and intermediate program states P1′, P2′, P3′, P4′, P5′, P6′, and P7′. The MSB data may be programmed in memory cells connected to a third word line of the buffer area 1113. Threshold voltage distributions of memory cells, connected to the first word line of the user data area 1115, formed after the coarse programming is executed may be illustrated in a box 23.

When programming (e.g., coarse programming) is performed on the second word line of the user data area 1115, threshold voltage distributions of memory cells connected to the first word line may widen due to the coupling effect. Threshold voltage distributions of memory cells, connected to the first word line of the user data area 1115, formed after the coupling is generated may be illustrated in a box 24.

When fine programming is carried out, the LSB data, the CSB data, and the MSB data may be read from the buffer area 1113. Thus, although the user data area 1115 experiences the coupling, the LSB data, the CSB data, and the MSB data may be read normally.

If the fine programming is performed, the LSB data, the CSB data, and the MSB data may be programmed in memory cells connected to the first word line of the user data area 1115. The memory cells may be programmed to have the erase state and program states P1, P2, P3, P4, P5, P6, and P7. Threshold voltage distributions of fine-programmed memory cells may be narrower than threshold voltage distributions of coarse-programmed memory cells. Threshold voltage distributions of memory cells, connected to the first word line of the user data area 1115, formed after the fine programming is executed may be illustrated in a box 25.

When programming (e.g., fine programming) is performed on the second word line of the user data area 1115, threshold voltage distributions of memory cells connected to the first word line may widen due to the coupling effect. Threshold voltage distributions of memory cells, connected to the first word line of the user data area 1115, formed after the coupling is generated may be illustrated in a box 26.

Margins among erase and program states may be sufficiently secured via the fine programming. Thus, although the coupling is generated, data programmed in memory cells connected to a first word line of the user data area 1115 may be read normally.

When the fine programming is executed, LSB data, CSB data, and MSB data may be loaded onto a RAM 1210 of the controller 1200. At this time, a state counter 1230 may count data loaded onto the RAM 1210 to generate state information SI. That is, an operation of reading data from the nonvolatile memory device 1100 may not be further required to generate the state information SI.

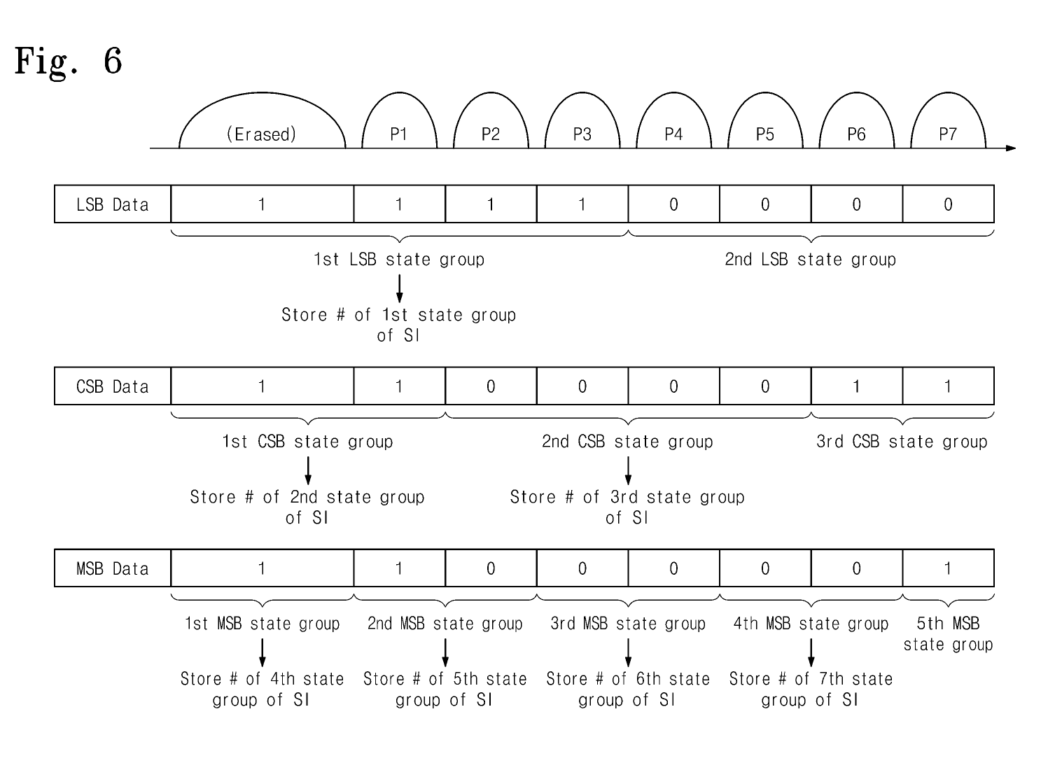

FIG. 6 is a diagram illustrating groups of logical states formed by LSB data, CSB data, and MSB data according to at least one example embodiment. The following table 1 may show logical states formed by LSB data, CSB data, and MSB data.

TABLE 1

| LSB data | CSB data | MSB data | Logical state |
|---|---|---|---|
| 1 | 1 | 1 | Erase state |
| 1 | 1 | 0 | P1 |
| 1 | 0 | 0 | P2 |
| 1 | 0 | 1 | P3 |
| 0 | 0 | 1 | P4 |
| 0 | 0 | 0 | P5 |
| 0 | 1 | 0 | P6 |
| 0 | 1 | 1 | P7 |

Erase and P1 through P3 states may correspond to LSB data being ‘1’, and P4 through P7 states may correspond to LSB data being ‘0’. The logical states corresponding to the LSB data being ‘1’ may form a first LSB state group, and the logical states corresponding to the LSB data being ‘0’ may form a second LSB state group. A state counter 1230 may count the number of data of the first LSB state group, and may output a count value as the number of data in the first state group of state information SI.

Erase and P1 states may correspond to CSB data being ‘1’, P2 through P5 states may correspond to CSB data being ‘0’, and P6 and P7 states may correspond to CSB data being ‘1’. Logical states (erase and P1 states) corresponding to CSB data being ‘1’ may form a first CSB state group, logical states (P2 through P5 states) corresponding to CSB data being ‘0’ may form a second CSB state group, and logical states (P6 and P7 states) corresponding to CSB data being ‘1’ may form a third CSB state group. The state counter 1230 may count the number of data of the first CSB state group and the number of data of the second CSB state group, and may output count values as the number of data in the second state group of state information SI and the number of data in the third state group of state information SI, respectively.

The erase state may correspond to MSB data being ‘1’, P1 and P2 states may correspond to MSB data being ‘0’, P3 and P4 states may correspond to MSB data being ‘1’, P5 and P6 states may correspond to MSB data being ‘0’, and the P7 state may correspond to MSB data being ‘1’. A logical state (erase state) corresponding to MSB data being ‘1’ may form a first MSB state group, logical states (P1 and P2 states) corresponding to MSB data being ‘0’ may form a second MSB state group, logical states (P3 and P4 states) corresponding to MSB data being ‘1’ may form a third MSB state group, logical states (P5 and P6 states) corresponding to MSB data being ‘0’ may form a fourth MSB state group, and a logical state (P7 state) corresponding to MSB data being ‘1’ may form a fifth MSB state group. The state counter 1230 may count the number of data of each of the first through fourth MSB state groups, and may output count values as the number of data in the fourth through seventh state groups of state information SI, respectively.

The following table 2 may show the number of data in first through seventh state groups of state information SI.

TABLE 2

| State group of SI | Number |
|---|---|
| First state group | Number of erase state and P1 through P3 states |
| | (number of data including LSB data being ‘1’) |
| Second state group | Number of erase state and P1 state |
| | (number of data including LSB and CSB data being |
| | ‘1’) |
| Third state group | Number of P2 through P5 states |
| | (number of data including CSB data being ‘0’) |
| Fourth state group | Number of erase state |
| | (number of data being ‘111’) |
| Fifth state group | Number of P1 and P2 states |
| | (number of data being ‘110’ and ‘100’) |
| Sixth state group | Number of P3 and P4 states |
| | (number of data being ‘101’ and ‘001’) |
| Seventh state group | Number of P5 and P6 states |
| | (number of data being ‘000’ and ‘010’) |

FIG. 7 is a flowchart illustrating a read method according to at least one example embodiment. In example embodiments, FIG. 7 shows a read operation S20 in FIG. 2 in detail. Referring to FIGS. 1 through 3 and 7, in operation S210, first data and second data may be read out from a user data area 1115. A nonvolatile memory device 1100 may read LSB data, CSB data, and MSB data from memory cells connected to a word line in the user data area 1115. The nonvolatile memory device 1100 may read data using read voltages having default levels. The read data may be output to a controller 1200.

In operation S215, error correction may be performed. The controller 1200 may correct an error of the read data using an error correction code 1220.

If the error is successfully corrected in operation S220, the method proceeds to operation S260, in which the read operation is determined as read success. Afterwards, the method may be ended. If error correction is failed in operation S220, the method proceeds to operation S25.

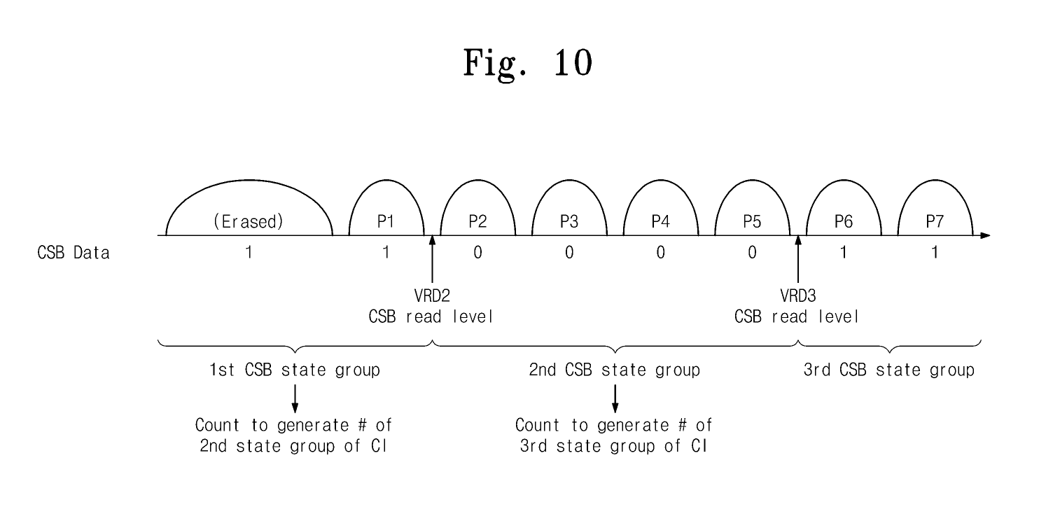

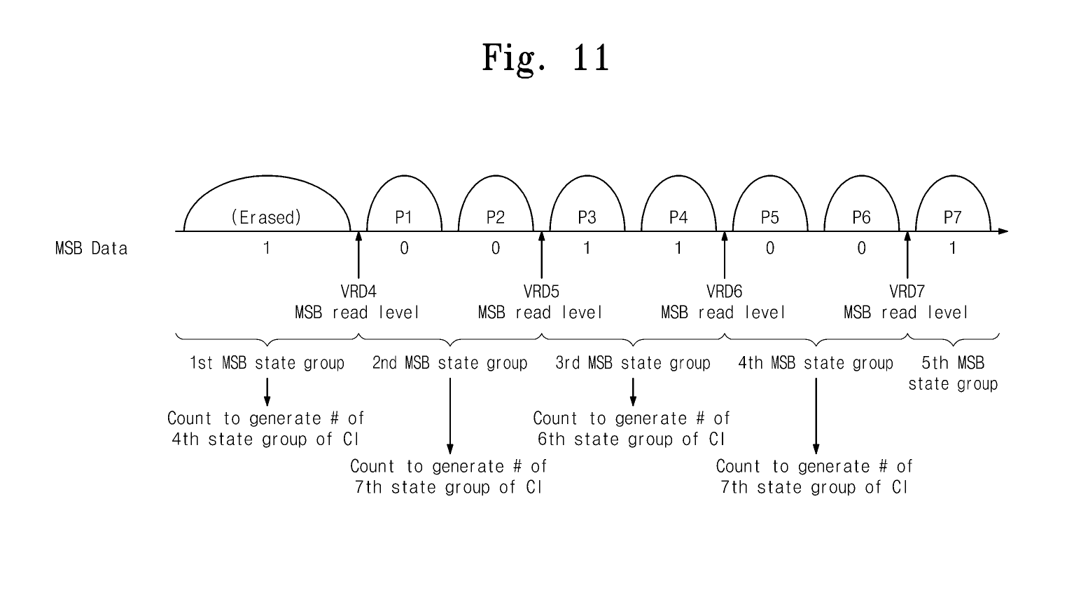

In operation S225, state information SI may be read from a meta area 1111, and first and second data may be read from the user data area 1115. The nonvolatile memory device 1100 may read the state information SI from the meta area 1111 and the first and second data from the user data area 1115. The read meta data and first and second data may be transferred to the controller 1200. In example embodiments, the first and second data may be read in a specific mode, not in a normal mode. A read operation executed in the specific mode will be more fully described with reference to FIGS. 10 and 11.

In operation S230, the first and second data may be counted to generate count information CI. A state counter 1230 may count the first and second data read (read in the specific mode) from the nonvolatile memory device 1100, that is, LSB data, CSB data, and MSB data, and may generate the count information CI. Like the state information SI, LSB data, CSB data, and MSB data may be counted by the group. The following table 3 may show the count information CI.

TABLE 3

| State group of CI | Number |
|---|---|
| First state group | Number of data read as one of erase and P1 through P3 |
| | states |
| | (number of data read as LSB data being ‘1’) |
| Second state | Number of data read as one of erase and P1 states |
| group | (number of data read as LSB and CSB data being ‘1’) |
| Third state group | Number of data read as one of P2 through P5 states |
| | (number of data read as CSB data being ‘0’) |
| Fourth state | Number of data read as erase state |
| group | (number of data read as ‘111’) |
| Fifth state group | Number of data read as one of P1 and P2 states |
| | (number of data read as ‘110’ and ‘100’) |
| Sixth state group | Number of data read as one of P3 and P4 states |
| | (number of data read as ‘101’ and ‘001’) |
| Seventh state | Number of data read as one of P5 and P6 states |
| group | (number of data read as ‘000’ and ‘010’) |

In operation S235, the state information SI may be compared with the count information CI to adjust levels of read voltages. The controller 1200 may compare the state information SI and the count information CI. The controller 1200 may adjust levels of read voltages according to the comparison result. The controller 1200 may provide the nonvolatile memory device 1100 with information on levels of read voltage to be adjusted, as a level shift signal LS.

In operation S240, the first and second data may be read using read voltages having adjusted levels. Control logic 1150 of the nonvolatile memory device 1100 may control a voltage generator 1160 in response to the level shift signal LS so as to output a read voltage VRD having adjusted levels. The read voltage VRD having adjusted levels may be provided to an address decoder 1120. The first and second data may be read from memory cells connected to a word line of the user data area 1115 using the read voltage VRD having adjusted levels.

In operation S250, error correction may be executed. If the error correction is judged to be successful, the method proceeds to operation S260, in which a read operation is determined as read success. Afterwards, the method may be ended. If the error correction is judged to be failed, the method proceeds to operation S255, in which a read operation is determined as read fail. Afterwards, the method may be ended.

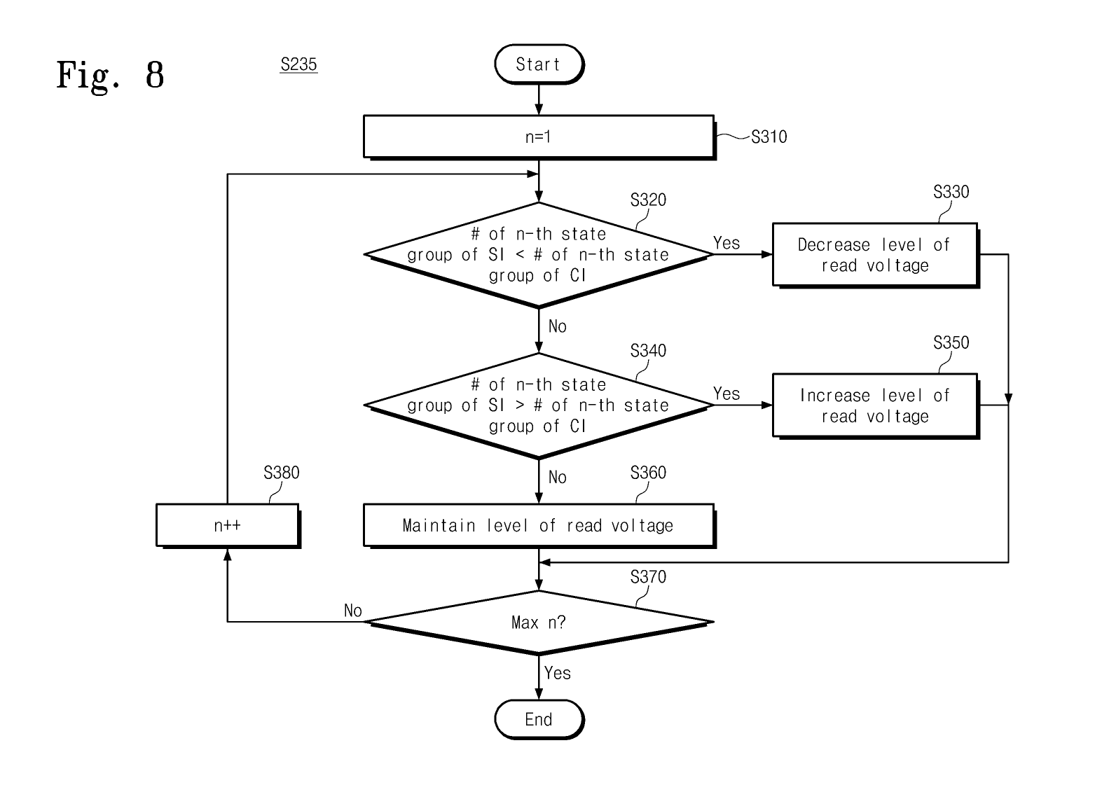

FIG. 8 is a flowchart for describing an operation S235 in FIG. 7 in detail. Referring to FIGS. 1, 7, and 8, in operation S310, a variable n may be reset to ‘1’.

In operation S320, there may be judged whether the number of data in an nth state group of state information SI is smaller than the number of data in an nth state group of count information CI. If the number of data in an nth state group of state information SI is smaller than the number of data in an nth state group of count information CI, the method proceeds to operation S330, in which a level of a read voltage decreases. For example, a level of a read voltage corresponding to the nth state group may decrease. Afterward, the method proceeds to operation S370. If the number of data in an nth state group of state information SI is not smaller than the number of data in an nth state group of count information CI, the method proceeds to operation S340.

In operation S340, whether the number of data in the nth state group of state information SI is larger than the number of data in the nth state group of count information CI may be judged. If the number of data in the nth state group of state information SI is larger than the number of data in the nth state group of count information CI, the method proceeds to operation S350, in which a level of a read voltage decreases. For example, a level of a read voltage corresponding to the nth state group may decrease. Afterwards, the method proceeds to operation S370. If the number of data in the nth state group of state information SI is not larger than the number of data in the nth state group of count information CI, the method proceeds to operation S360, in which a level of a read voltage is maintained.

If operations S320 through S360 are performed, a level of a read voltage may be adjusted according to the number of data in the nth state group of the state information SI and the number of data in the nth state group of the count information CI. For example, there may be adjusted a level of a read voltage associated with the nth state groups.

In operation S370, whether the variable n has the maximum value may be judged. For example, whether a level of a read voltage is adjusted via operations S320 through S360 may be judged according to data of the last state groups of the state and count information SI and CI. If the variable n does not have the maximum value, the method proceeds to operation S380, in which a value of the variable n increases. Afterwards, the method proceeds to operation S320. That is, a level of a read voltage may be adjusted according to data of next state groups of the state and count information SI and CI. If the variable n has the maximum value, that is, if a level of a read voltage is adjusted according to data of all state groups of the state information SI or the count information CI, comparing of the state information SI and the count information CI and adjustment of a read voltage may be ended.

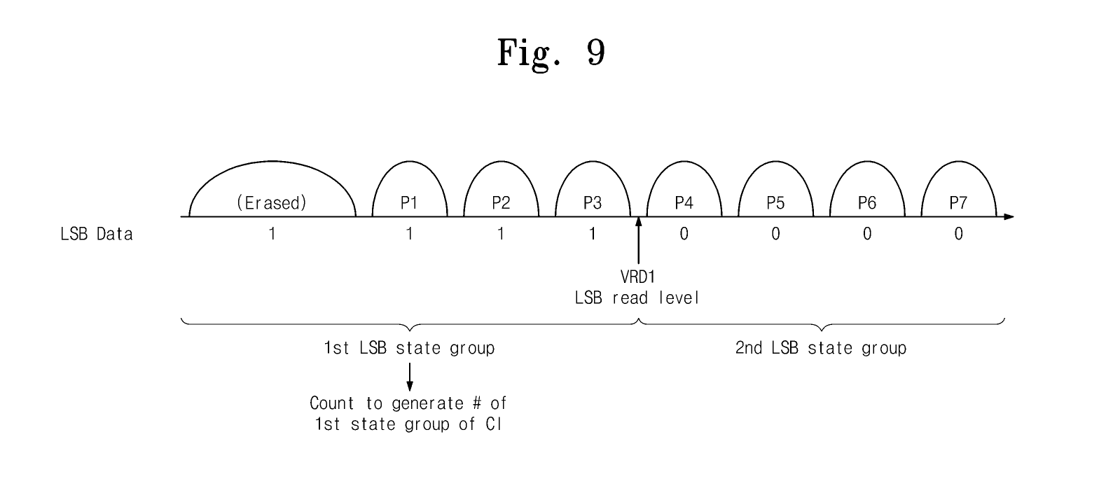

FIGS. 9 through 11 are diagrams for describing a procedure in which count information CI is generated. In FIGS. 9 through 11, a horizontal axis may indicate a threshold voltage of a memory cell, and a vertical axis may indicate the number of memory cells.

Referring to FIGS. 1, 3, and 9, a first read voltage VRD1 may be used to read LSB data that is stored in memory cells connected to a word line of a user data area 1115. Memory cells each having a threshold voltage lower than the first read voltage VRD1 may be read as data ‘1’. Data read from the memory cells may be judged as one of erase and P1 through P3 states, and may be a first LSB state group. Memory cells each having a threshold voltage higher than the first read voltage VRD1 may be read as data ‘0’. Data read from the memory cells may be judged as one of P4 through P7 states, and may be a second LSB state group. Data read to be the first LSB state group may be counted as a first state group of count information CI.

The number of data in the first state group of state information SI may indicate the number of data programmed to one of erase and P1 through P3 states. The number of data in the first state group of count information CI may indicate the number of data read as one of the erase and P1 through P3 states. If a read error is generated, the number of data in the first state group of the state information SI may be different from the number of data in the first state group of the count information CI. That is, when the number of data in the first state group of the state information SI is different from the number of data in the first state group of the count information CI, a level of the first read voltage VRD1 may be adjusted such that the number of data in the first state group of the state information SI is identical to the number of data in the first state group of the count information CI. Thus, a read error may decrease.

As described in relation to FIG. 8, if the number of data in the first state group of the state information SI is smaller than the number of data in the first state group of the count information CI, a level of the first read voltage VRD1 may decrease. If a level of the first read voltage VRD1 decreases, the number of data in the first state group of the count information CI may decrease. That is, the number of data in the first state group of the state information SI may become identical to the number of data in the first state group of the count information CI, and a read error may decrease.

If the number of data in the first state group of the state information SI is larger than the number of data in the first state group of the count information CI, a level of the first read voltage VRD1 may increase. If a level of the first read voltage VRD1 increases, the number of data in the first state group of the count information CI may increase. That is, the number of data in the first state group of the state information SI may become identical to the number of data in the first state group of the count information CI, and a read error may decrease.

Referring to FIGS. 1, 3, and 10, second and third read voltages VRD2 and VRD3 may be used to read CSB data stored in memory cells connected to a word line of the user data area 1115.

Memory cells each having a threshold voltage lower than the second read voltage VRD2 may be read as data ‘1’. Data read from the memory cells may be judged as one of erase and P1 states, and may be a first CSB state group. Memory cells each having a threshold voltage higher than the second read voltage VRD2 and lower than the third read voltage VRD3 may be read as data ‘0’. Data read from the memory cells may be judged as one of P1 through P5 states, and may be a second CSB state group. Data read to be the first CSB state group may be counted as a second state group of count information CI. Data read to be the second CSB state group may be counted as a third state group of the count information CI.

A level of the second read voltage VRD2 may be adjusted such that the number of data in the second state group of the state information SI is identical to the number of data in the second state group of the count information CI. A level of the third read voltage VRD3 may be adjusted such that the number of data in the third state group of the state information SI is identical to the number of data in the third state group of the count information CI.

In example embodiments, when CSB data is read in a normal mode, there may be judged whether data of a specific memory cell is ‘1’ or ‘0’. When data of a specific memory cell is ‘1’, whether or not to belong to the first CSB state group or the third CSB state group may not be judged at the normal read operation.

At a read operation of a specific mode, a nonvolatile memory device 1100 may perform a read operation by applying the second read voltage VRD2 to a word line. As a read operation is executed using the second read voltage VRD2, a first CSB state group and remaining CSB state groups may be judged. A read result may be output to a controller 1200. Afterwards, the nonvolatile memory device 1100 may perform a read operation by applying the third read voltage VRD3 to a word line. As a read operation is executed using the third read voltage VRD3, a third CSB state group and remaining CSB state groups may be judged. A read result may be output to the controller 1200.

The controller 1200 may receive the read results from the nonvolatile memory device 1100 to judge a first CSB state group, a second CSB state group, and a third CSB state group, respectively. The controller 1200 may generate the count information CI by performing a count operation according to the judgment.

Referring to FIGS. 1, 3, and 11, fourth through seventh read voltages VRD4 through VRD7 may be used to read MSB data stored in memory cells connected to a word line of the user data area 1115.

Memory cells each having a threshold voltage lower than the fourth read voltage VRD4 may be read as data ‘1’. Data read from the memory cells may be judged as an erase state, and may be a first MSB state group. Memory cells each having a threshold voltage higher than the fourth read voltage VRD4 and lower than the fifth read voltage VRD5 may be read as data ‘0’. Data read from the memory cells may be judged as one of P1 and P2 states, and may be a second MSB state group. Memory cells each having a threshold voltage higher than the fifth read voltage VRD5 and lower than the sixth read voltage VRD6 may be read as data ‘1’. Data read from the memory cells may be judged as one of P3 and P4 states, and may be a third MSB state group. Memory cells each having a threshold voltage higher than the sixth read voltage VRD6 and lower than the seventh read voltage VRD7 may be read as data ‘0’. Data read from the memory cells may be judged as one of P5 and P6 states, and may be a fourth MSB state group. Memory cells each having a threshold voltage higher than the seventh read voltage VRD7 may be read as data ‘1’. Data read from the memory cells may be judged as one of a P7 state, and may be a fifth MSB state group.

Data read to be the first MSB state group may be counted as a fourth state group of the count information CI. Data read to be the second MSB state group may be counted as a fifth state group of the count information CI. Data read to be the third MSB state group may be counted as a sixth state group of the count information CI. Data read to be the fourth MSB state group may be counted as a seventh state group of the count information CI.

A level of the fourth read voltage VRD4 may be adjusted such that the number of data in the fourth state group of the state information SI is identical to the number of data in the fourth state group of the count information CI. A level of the fifth read voltage VRD5 may be adjusted such that the number of data in the fifth state group of the state information SI is identical to the number of data in the fifth state group of the count information CI. A level of the sixth read voltage VRD6 may be adjusted such that the number of data in the sixth state group of the state information SI is identical to the number of data in the sixth state group of the count information CI. A level of the seventh read voltage VRD7 may be adjusted such that the number of data in the seventh state group of the state information SI is identical to the number of data in the seventh state group of the count information CI.

As described in relation to FIG. 10, the nonvolatile memory device 1100 may perform a read operation of a specific mode. The nonvolatile memory device 1100 may perform a read operation using fourth through seventh read voltages VRD4 through VRD7 to output read results to the controller 1200. The controller 1200 may judge first through fifth MSB state groups using the read results. The controller 1200 may generate count information CI according to the judgment.

As described above, the nonvolatile memory device 1100 and the memory system 1000 according to at least one example embodiment may count groups of data to be programmed and groups of read data. Levels of read voltages may be adjusted (or, tracked) based on a comparison result of the count results. Thus, there may be provided a memory system including a nonvolatile memory device with the improved reliability and a control method of controlling the nonvolatile memory device.

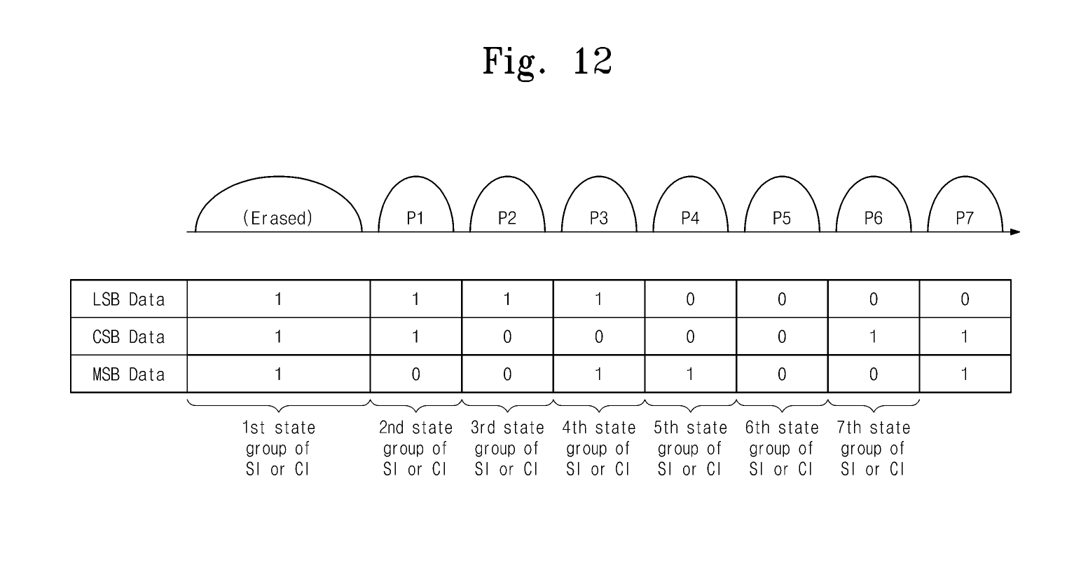

FIG. 12 is a diagram illustrating groups of logical states formed by LSB data, CSB data, and MSB data according to at least one example embodiment. Referring to FIG. 12, erase and P1 through P6 states may be first through seventh state information of state information SI or count information CI, respectively.

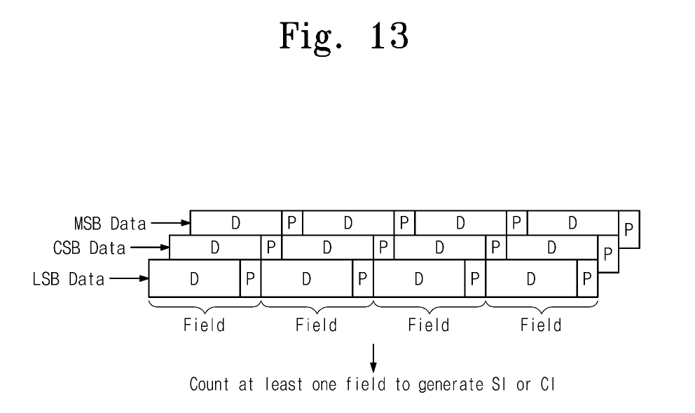

State groups of state information SI or count information CI are not limited to an embodiment illustrated in FIGS. 9 through 11. As described with reference to FIGS. 12 and 13, state groups of state information SI or count information CI may be modified and applied variously.

Example embodiments are described above as using values of concrete bits pointing at an erase state and program states P1 through P7. However, values of concrete bits pointing at an erase state and program states P1 through P7 are not limited thereto. According to at least one example embodiment, the correspondence between particular bit values “000”, “001”, “010”, etc and each of the erase state and the program states P1 through P7, respectively, may be different than that described above with reference to FIGS. 1-12.

FIG. 13 is a diagram illustrating another example for generating state information SI and count information CI. Referring to FIGS. 1 and 13, memory cells connected to a word line may store LSB data, CSB data, and MSB data. Each of the LSB, CSB, and MSB data may include a plurality of fields. Each field may include data D and a parity P. The parity P may be additional information for error correction. An error of data D may be corrected using the parity P in a field corresponding to the data D. That is, a field may be an error correction unit.

A controller 1200 may count data of groups in at least one of fields of LSB, CSB, and MSB data to be programmed to generate state information SI. The controller 1200 may count data of groups in at least one of fields of read LSB, CSB, and MSB data to generate count information CI. That is, the state information SI and the count information CI may be generated using a part (at least one field) of data programmed in memory cells connected to a word line, not all of the data. At this time, since a count time taken to generate the state information SI and the count information CI is reduced, a time taken to adjust levels of a read voltage may be reduced.

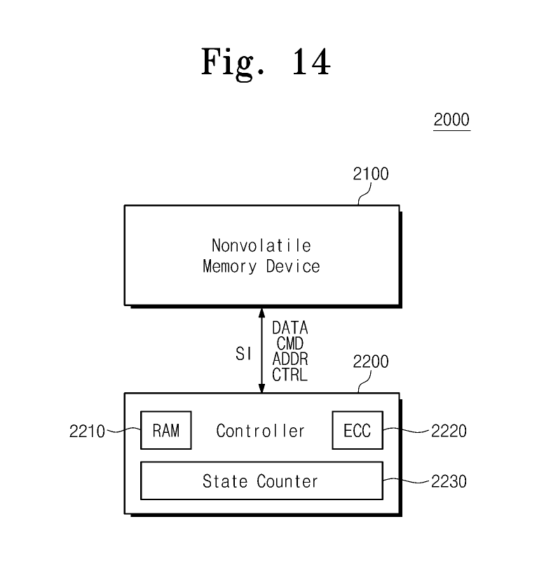

FIG. 14 is a block diagram schematically illustrating a memory system according to at least one example embodiment. Compared with a memory system 1000 in FIG. 1, a controller 2200 may not provide a nonvolatile memory device 2100 with a level shift signal LS.

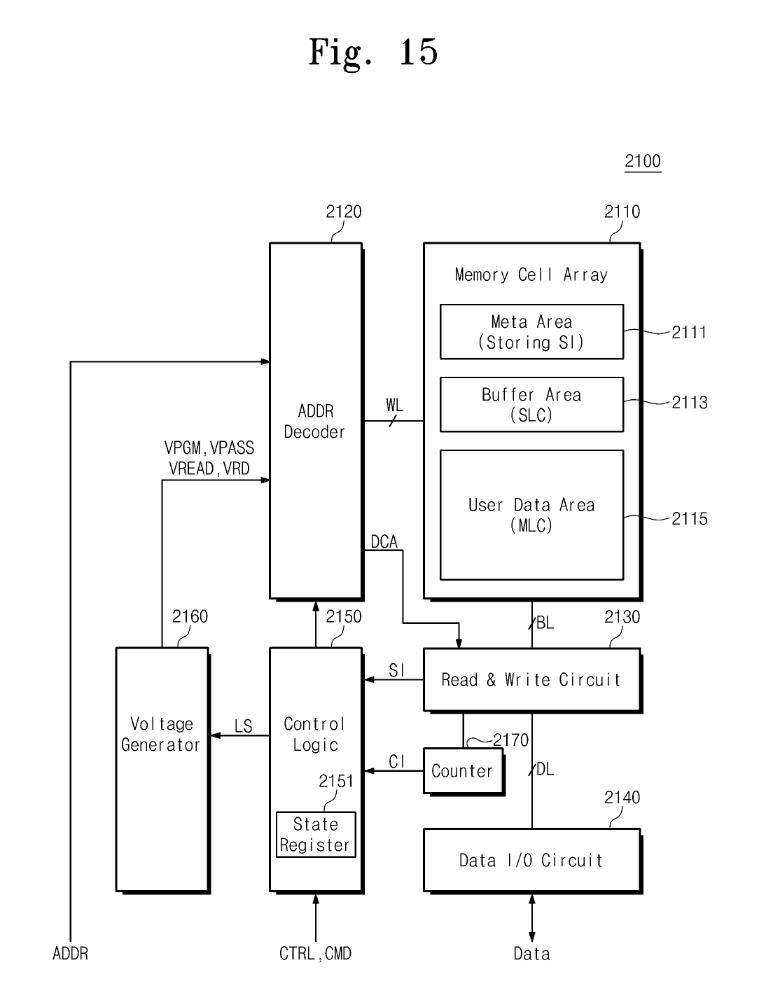

FIG. 15 is a block diagram schematically illustrating a nonvolatile memory device in FIG. 14. Compared with a nonvolatile memory device 1100 in FIG. 3, a nonvolatile memory device 2100 may further include a counter 2170, and control logic 2150 may include a state register 2151.

The counter 2170 may count data read from memory cells connected to a word line of a user data area 2115, to generate count information CI. The counter 2170 may count the number of data in each of groups of the read data to generate count information CI.

The state register 2150 may store state information read from a meta area 2111 and the count information CI output from the counter 2170.

The control logic 2150 may compare the state information SI with the count information CI, and may output a level shift signal LS for adjusting levels of read voltages according to the comparison. The level shift signal LS may be transferred to a voltage generator 2160.

That is, at programming, a controller 2200 may generate the state information SI to store it in the nonvolatile memory device 2100. At reading, the nonvolatile memory device 2100 may generate count information CI, compare the state information SI and the count information CI, and adjust levels of a read voltage according to the judgment.

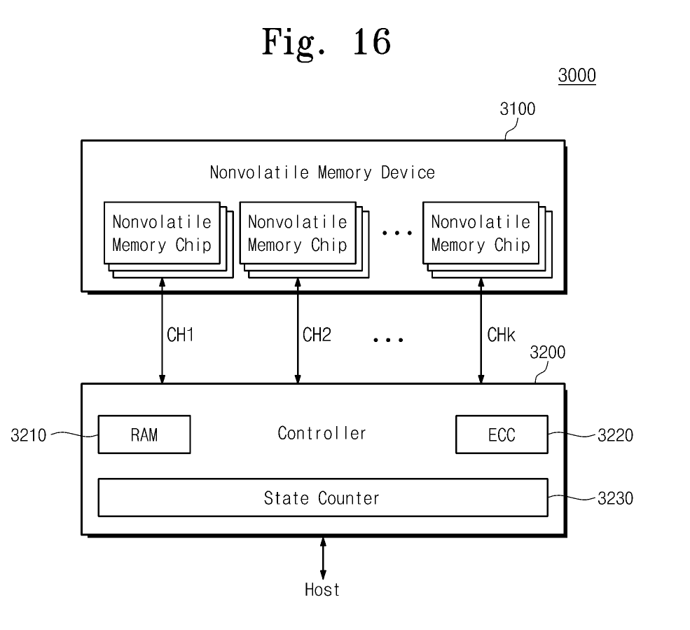

FIG. 16 is a block diagram schematically illustrating an application of a memory system in FIG. 1. Referring to FIG. 16, a memory system 3000 may include a nonvolatile memory device 3100 and a controller 3200. The nonvolatile memory device 3100 may include a plurality of nonvolatile memory chips, which form a plurality of groups. Nonvolatile memory chips in each group may be configured to communicate with the controller 3200 via one common channel. In example embodiments, the plurality of nonvolatile memory chips may communicate with the controller 3200 via a plurality of channels CH1 to CHk.

The controller 3200 may include a RAM 3210, an error correction code 3220, and a state counter 3230. The memory system 3000 may generate state information SI and count information CI, compare the state information SI and the count information CI, and adjust levels of read voltages according to the comparison.

In FIG. 16, there is described the case that one channel is connected with a plurality of nonvolatile memory chips. However, the memory system 3000 can be modified such that one channel is connected with one nonvolatile memory chip.

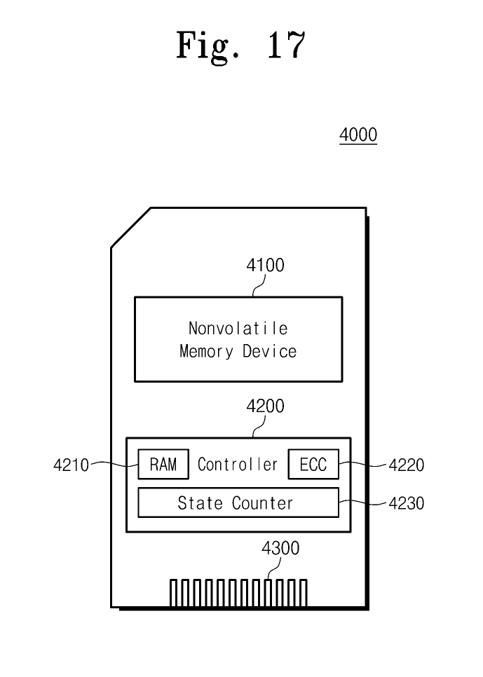

FIG. 17 is a diagram illustrating a memory card according to at least one example embodiment. Referring to FIG. 17, a memory card 4000 may include a nonvolatile memory device 4100, a controller 4200, and a connector 4300.

The controller 4200 may include a RAM 4210, an error correction code 4220, and a state counter 4230. The memory system 4000 may generate state information SI and count information CI, compare the state information SI and the count information CI, and adjust levels of read voltages according to the comparison.

The connector 4300 may connect the memory card 4000 with a host electrically.

The memory card 4000 may be formed of memory cards such as a PC (PCMCIA) card, a CF card, an SM (or, SMC) card, a memory stick, a multimedia card (MMC, RS-MMC, MMCmicro), a security card (SD, miniSD, microSD, SDHC), a universal flash storage (UFS) device, and the like.

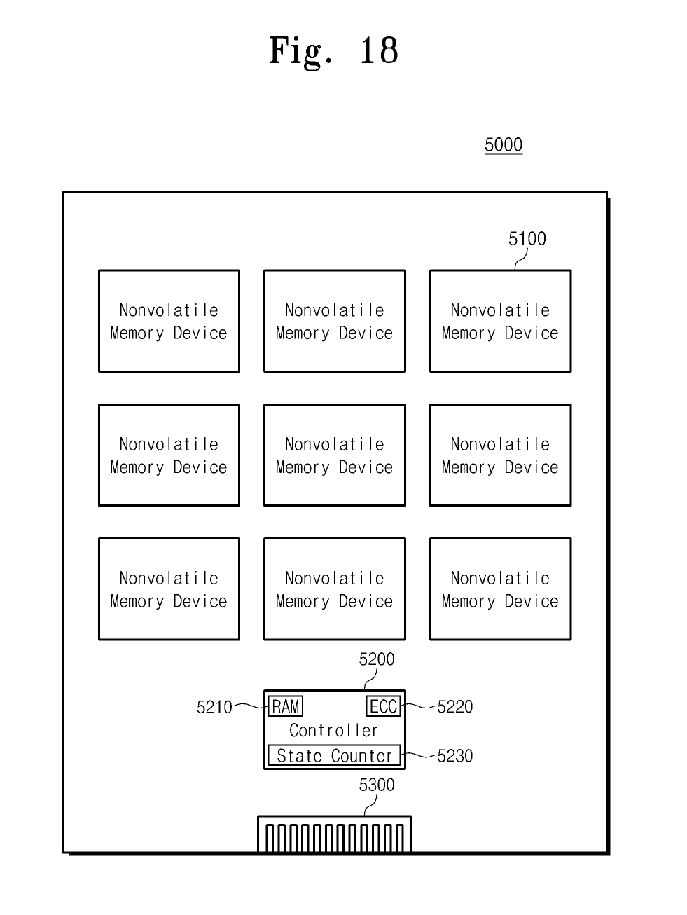

FIG. 18 is a diagram illustrating a solid state drive according to at least one example embodiment. Referring to FIG. 18, a solid state drive 5000 may include a plurality of nonvolatile memory devices 5100, a controller 5200, and a connector 5300.

The controller 5200 may include a RAM 5210, an error correction code 5220, and a state counter 5230. The memory system 5000 may generate state information SI and count information CI, compare the state information SI and the count information CI, and adjust levels of read voltages according to the comparison.

The connector 5300 may connect the solid state drive 5000 with a host electrically.

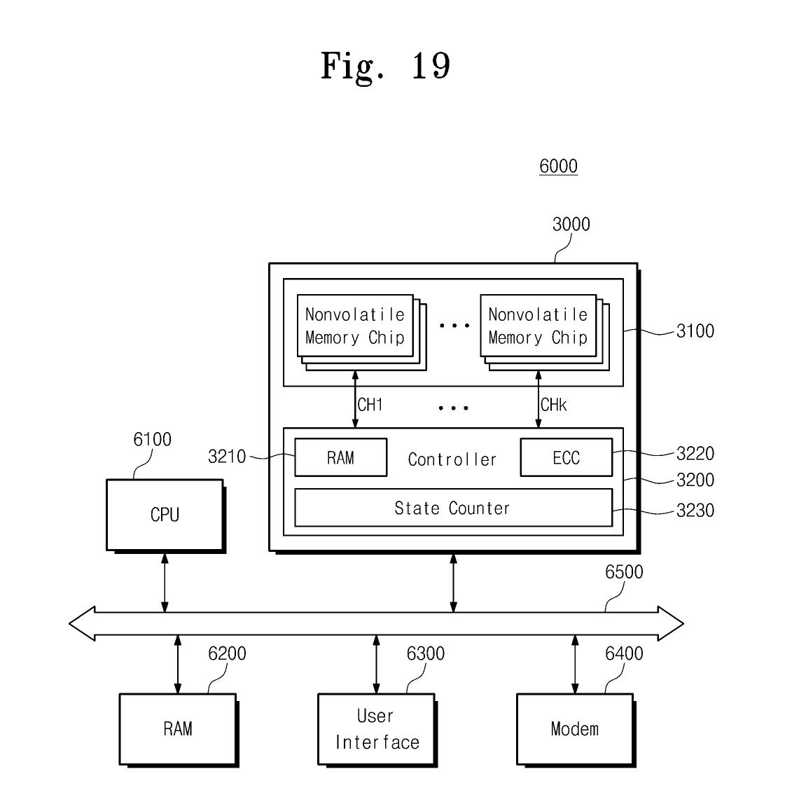

FIG. 19 is a block diagram illustrating a computing system according to at least one example embodiment. Referring to FIG. 19, a computing system 6000 may include a central processing unit 6100, a RAM 6200, a user interface 6300, a power supply 6400, and a memory system 3000.

The memory system 3000 may be connected electrically with the elements 6100 through 6400 via a system bus 6500. Data provided via the user interface 6300 or processed by the central processing unit 6100 may be stored in the memory system 3000.

In FIG. 19, there is illustrated the case that a nonvolatile memory device 3100 is connected to the system bus 6500 via a controller 3200. However, the nonvolatile memory device 3100 can be electrically connected directly to the system bus 6500.

The memory system 3000 in FIG. 19 may be a memory system described in relation to FIG. 16. However, the memory system 3000 can be replaced with a memory system 1000 described with reference to FIG. 1.

According to at least one example embodiment, when data is programmed, state information may be generated together. When data is read, count information may be generated, the generated count information may be compared with state information, and levels of read voltages may be adjusted according to the comparison. Thus, since levels of read voltages are adjusted according to a state of data written in memory cells, a memory system including a nonvolatile memory device with the improved reliability and a method of controlling the nonvolatile memory device may be provided.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A method of controlling a nonvolatile memory device comprising:
programming data in a user data area of the nonvolatile memory device and state information on logical states of the data in a meta area of the nonvolatile memory device; and
adjusting levels of a plurality of read voltages using the state information to read the data from the user data area using the plurality of read voltages having the adjusted levels.

2. The method of claim 1, wherein the programming data in a user data area of the nonvolatile memory device and state information on logical states of the data in a meta area of the nonvolatile memory device comprises:
programming first data in first memory cells of the user data area and second memory cells of a buffer area of the nonvolatile memory device;
receiving second data, reading the first data from the second memory cells, coarse programming the first and second data in the first memory cells, and programming the second data in third memory cells of the buffer area; and
reading the first and second data from the second and third memory cells, grouping logical states, which the first and second data indicate, into a plurality of groups, counting the number of data in each of some groups of the plurality of groups to generate the state information, fine programming the first and second data in the first memory cells, and programming the state information in the meta area.

3. The method of claim 2, wherein the first data includes Least Significant Bit (LSB) data and central significant bit (CSB) data.

4. The method of claim 2, wherein the second data includes most significant bit (MSB) data.

5. The method of claim 2, wherein the meta area includes spare memory cells connected to word lines of the nonvolatile memory device.

6. The method of claim 2, wherein the meta area includes at least one memory block.

7. The method of claim 2, wherein the state information includes information on the number of data of groups of logical states of a part of the first data and the number of data of groups of logical states of a part of the second data.

8. The method of claim 2, wherein the adjusting levels of a plurality of read voltages using the state information to read the data from the user data area using the plurality of read voltages having the adjusted levels includes:
reading the first and second data from the first memory cells;
performing error correction on the first and second data; and
if the error correction is failed, reading the state information from the meta area, counting groups of logical states of the read first and second data to generate count information, comparing the state information and the count information to adjust levels of the read voltages, and reading the first and second data using the read voltages having the adjusted levels.

9. The method of claim 8, wherein when the number of data in an nth group of the state information is greater than the number of data in an nth group of the count information, a level of a read voltage corresponding to the nth group increases.

10. The method of claim 8, wherein when the number of data in an nth group of the state information is smaller than the number of data in an nth group of the count information, a level of a read voltage corresponding to the nth group decreases.

11. The method of claim 8, wherein logical states that the first and second data indicate form two groups from among the plurality of groups of logical states according to a level of a read voltage used when LSB data is read, respectively.

12. The method of claim 11, wherein logical states that the first and second data indicate form three groups from among the plurality of groups of logical states according to levels of read voltages used when CSB data is read, respectively.

13. The method of claim 11, wherein logical states that the first and second data indicate form five groups from among the plurality of groups of logical states according to levels of read voltages used when MSB data is read, respectively.

14. The method of claim 13, wherein data numbers of one of two groups corresponding to the LSB data from among the plurality of groups of logical states, two ones of three groups corresponding to the CSB data from among the plurality of groups of logical states, and four ones of five groups corresponding to the MSB data from among the plurality of groups of logical states are counted as the state information and the count information.

15. (canceled)

16. A method of handling data of a nonvolatile memory device comprising:
generating state information based on the data, the data representing a plurality of logic values each of which corresponds to one of a plurality of different logic states, the state information identifying a distribution of the logic states corresponding to the plurality of logic values;
programming the data and the state information into the nonvolatile memory device; and
reading the programmed data using the state information.

17. The method of claim 16, wherein the reading includes:
adjusting levels of a plurality of read voltages based on the state information, and
reading the data from a user data area of the nonvolatile memory device using the plurality of read voltages having the adjusted levels.

18. The method of claim 17, wherein the adjusting includes:
reading the programmed data;
generating count information based on the programmed data, the count information identifying a distribution of the logic states corresponding to the plurality of logic values;
generating a comparison result based on the count information and the programmed state information; and
adjusting levels of the plurality of read voltages based on the comparison result.

19. The method of claim 16, wherein the plurality of different logic states are arranged into a plurality of groups such that each of the plurality of groups includes one or more of the plurality of logic states, and
for each of the plurality of groups, the state information indicates how many of the logic values of data correspond to logic states are included in the group.
